(19) United States
(12) Patent Application Publication
(10) Pub. No.: US 2002/0148156 A1
(43) Pub. Date: Oct. 17, 2002

(54) Loop fishhook

(76) Inventor: Bradley William Damm, Tigard, OR (US)

Correspondence Address: Bradley William Damm, 15935 SW Bull Mountain Road, Tigard, OR, 97224, US

(21) Appl. No.: 10/122,091

(22) Filed: Apr. 12, 2002

Related U.S. Application Data
(60) Provisional application No. 60/283,866, filed on Apr. 16, 2001.

(51) Int. Cl. A01K 83/00

(52) U.S. Cl. 43/43.16

(57) ABSTRACT

A fishhook having improved fish retention characteristics is described, the fishhook does not have a conventional barb, but rather a novel loop is formed in the curved shank of the hook to reliably bind and hold the fishhook in the tissue of a fish until intentional removal by an angler.

### CROSS REFERENCE TO RELATED APPLICATIONS

This application is entitled to the benefit of the Provisional Patent Application titled “Loop Fishhook”, Serial No. 60/283,886 which was filed on Apr. 12, 2001.

### BACKGROUND

1. Field of Invention

This Invention relates to fishing equipment and more particularly to a fishhook in which a loop is formed in the shank of the hook that both holds and binds the hook in the tissue of a fish irrespective of the overall shape or size of the fishhook.

2. Description of Prior Art

Fishing by the means of a hook attached to the end of a line has been practiced for all of recorded history. The modern fishhook as shown in FIG. 5B of the accompanying drawings was invented thousands of years ago. A barb as shown in FIG. 5A was later added and has remained the standard practice to assure a hook remains embedded in the tissue of a fish. In a Thirteenth Century improvement, fishhooks were first made of steel. Although little or no further development of the basic structure has occurred in the last five hundred years, an ironic twist has occurred and the barbless fishhook of previous use has once again become popular for sport fishing due to the disadvantages of a barbed fishhook.

The essence of sport fishing it is the desire of an angler to hook and retrieve a fish. In some cases the fish is then retained by the angler, while in other cases the fish is released unharmed. If the angler desires to retain a fish that is caught, a hook that is not easily dislodged from the fish is required. If the angler desires to release the fish, a hook unlikely to injure or damage the fish is required. These basic requirements are somewhat contradictory in terms of the type of hook apparatus used. Even if it is the general desire of the angler to retain any fish caught, it may be impossible to know if a hooked fish is legal to keep until the fish is examined by the angler for size, species, etc.

Structures vital to the survival of a fish such as the gills and the throat are located in or near the mouth of the fish. Damage to these structures can prove fatal. All conventional fishhooks can and often do penetrate these structures. A conventional barbed fishhook is difficult to remove, and will often tear and injure or damage vital organs of a fish during removal. Because this injury sometimes proves fatal, barbed hooks have now been banned in many circumstances. A barbless fishhook generally does not prove damaging in and of itself, yet conventional barbless hooks are often dislodged during retrieval, allowing the fish to escape prior to the point where a fish can be examined and released if circumstances provide.

In addition, during the course of fishing an accident will occasionally occur where a hook point will penetrate the skin of an angler. If the point is barbed removal is both difficult and painful. To remove a barbed hook embedded in his or her flesh the angler must continue to push the point of the hook through his or her flesh until the point exits the skin and the barb is clear. The shank of the hook is then cut, and the hook is then removed from the entry or exit wound.

Several inventors have tried to improve the holding characteristics of a barbless fishhook. U.S. Pat. No. 5,685,108 to Lepage et al. (1997) describes a fishhook with “fish retaining depressions” in the point of the hook. In practice the depressions are extremely small grooves that are smaller than the diameter of the shank of the hook that can hold a similarly extremely small portion of the tissue of a fish. Because of this, these depressions have minimal holding characteristics.

Other versions of the essentially the same basic idea incorporate various combinations of small protrusions instead of depressions in the point of a barbless hook. Such protrusions have similar limitations to the depressions described above. In addition, most protrusions decrease the ability of a barbless hook point to effect penetration of the tissue of a fish in direct proportion to their improved holding characteristics. In U.S. Pat. No. 4,723,372 to Moser (1988) two “nodes” configured in a spade-like shape at the point of the hook are described. U.S. Pat. No. 5,386,660 to Levin (1995) describes a “semi-tear-drop shaped, relatively blunt, edge surface” to accomplish a similar result. In order for these or similar protrusions to easily penetrate the tissue of a fish they must be relatively small, and as a result have minimal holding ability.

In an attempt to increase the holding ability and effectiveness of various different combinations of grooves, protrusions, roughened areas and the like, U.S. Pat. No. 4,028,838 to Flower (1977) describes a “Clamper Fishhook” with a “constricted throat”. In this application the tissue of a fish is forced into the constricted area of the hook and thereby forced into the combination of protrusions and depressions. The disadvantage of this is that the extreme resistance to full penetration of the hook caused by the need to force the tissue of a fish into the constricted throat envisioned by this application is only marginally offset by the by the minimal resistance of this hook accidental dislodgment.

In order to overcome the disadvantages of penetration resistance by various protrusions and combinations of protrusions, U.S. Pat. No. 5,097,622 to James (1992) describes the use a sleeve of dissimilar material which forms a protrusion after the hook is engaged. In this version a sleeve of material deposited on the shank of the hook near the tip which “is caused, by frictional engagement, to roll up or bunch up against itself against the interior layer of the mouth of the fish” is used improve the holding characteristics of a barbless fishhook. While such a combination may increase resistance to accidental dislodgment without increased penetration resistance, it is more complex, requires multiple parts, is more expensive to manufacture, and makes no provision for ease of removal without injury to a fish upon intentional release by the angler.

U.S. Pat. No. 3,827,174 to Banker (1974) Titled “Fish Releasing Hook” describes a complex fish hook assembly with multiple parts designed such that when pulled, a line attached to a lever inside of a spring biased sleeve mounted on a shank inside of a second sleeve trips the pivotably mounted point of the hook which rotates and releases the fish. U.S. Pat. No. 4,998,375 to Mitchell (1991) describes a similarly complex arrangement wherein the fishhook is hollow and a barb retracts when one of two wires is pulled. In U.S. Pat. No. 5,339,562 to Guerra et al. (1994) the point and barb are eliminated entirely and series of levers designed to clamp the head of a fish are in a tongs-like action are described. U.S. Pat. No. 5,884,428 to Shelton (1999) describes another complex arrangement wherein a line or leader is attached below a sliding sleeve which must be removed from the shank portion of the hook by the angler prior to releasing the fish. None of these or similar devices have gained angler acceptance as they either rely on multiple parts or complex arrangements that are impractical for angler use and expensive to manufacture while providing little advantage over a conventional barbed or barbless fishhook.

A hook apparatus of some sort is essential for most fishing activity. Prior to recent times the ability to catch and then release the fish caught uninjured for sport has been of only minimal concern. A standard fishhook typically includes a barb which often may preclude the release of the fish uninjured. For this reason barbs have been banned in many circumstances. Many anglers find the use of a barb unethical if the intention of the angler is to release the fish Removal of the barb decreases the effectiveness of the hook. Several types of hooks have been proposed to solve these problems, none are entirely satisfactory. All of the heretofore known fishhooks suffer from one or more of the following disadvantages.

a) If one uses a barb for a means by which a hook is retained in the tissue of a fish, the fish is often injured during hook removal. This injury can be fatal if the hook is embedded in a vital organ of the fish.

b) If one uses a barbless hook, the hook is susceptible to accidental dislodgment from the mouth of a fish following the initial action by fish or angler to effect penetration of the hook in the tissue of the fish.

c) If one replaces a standard barb on a hook with protrusions, depressions, or combinations thereof the hook has either increased resistance to penetration or minimal holding characteristics or both.

d) If one uses a complex mechanical arrangement to effect the release of a fish, the apparatus proves to be expensive, impractical for use, and will not gain angler acceptance.

### SUMMARY

In accordance with the present invention a novel loop that both holds and binds the hook in the tissue of a fish is formed in a fishhook body comprised of a method of attachment to a line or leader and a shank having a curved section that terminates in a sharp point. The loop is formed integral with the shank of the hook, and is formed in addition to and irrespective of the predetermined basic shape of the hook.

### OBJECTS AND ADVANTAGES

Accordingly the objects and advantages of the present invention are:

a) to provide a fishhook that easily penetrates the tissue of a fish;

b) to provide a fishhook that remains embedded in a fish until intentional removal by an angler;

c) to provide a fishhook that can be removed from a fish quickly and without difficulty;

d) to provide a fishhook that can be removed from a fish with little or no injury to the fish;

e) to provide a fish hook more likely to penetrate non vital areas of a fish;

f) to provide a fishhook that can be removed from the flesh of a angler with minimal injury;

g) to provide a fish hook of simple design;

h) to provide a fishhook inexpensive manufacture;

i) to provide a fishhook adaptable in size to be effective in angling for species of fish; and

j) to provide a fishhook adaptable in overall shape to be effective in all methods of angling.

Further objects and advantages are to provide a effective fishhook that combines the advantages of both barbed and barbless fishhooks of present use and which will gain angler acceptance through compatibility with standard sport fishing techniques. A further object and advantage is to provide a fishhook that is legal to use where barbed hooks are prohibited and ethical to use in catch and release fishing. Still further objects and advantages will become apparent from a consideration of the ensuing description and drawings.

### DRAWING FIGURES

In the drawings, wherein the showings are for the purpose of illustrating a preferred embodiment of the invention and not for the purpose of limiting same, closely related figures have the same number but different alphabetic suffixes.

FIG. 1 shows a fishhook supplied with a loop for the purpose of holding and binding the tissue of a fish.

FIGS. 2A and 2B show the longitudinal axis and various dimensional relationships of a similar fishhook.

FIGS. 3A to 3C further illustrate the previous showings from various from different perspectives.

FIG. 4 makes obvious the location of correlating parts of previous drawings of differing perspectives.

FIGS. 5A and 5B represent prior art, and show standard barbed and barbless fishhooks of present use.

### REFERENCE NUMERALS IN DRAWINGS

11 eye or other means of attachment to a line or leader

12 barbless fishhook point

13 shank portion of fishhook

14 loop formed in fishhook shank

21 distance from fishhook point to fishhook shank

22 diameter of fishhook loop

23 central longitudinal axis of fishhook body

24 upper portion of fishhook shank

25 angle formed curve in upper portion of fishhook shank

26 portion of fishhook shank leading into loop portion of fishhook shank

27 angle formed by curved portion of fishhook shank

28 portion of fishhook shank leading into fishhook point

31 gap in fishhook loop formed by twist in fishhook body

51 barb portion of conventional fishhook

### DESCRIPTION

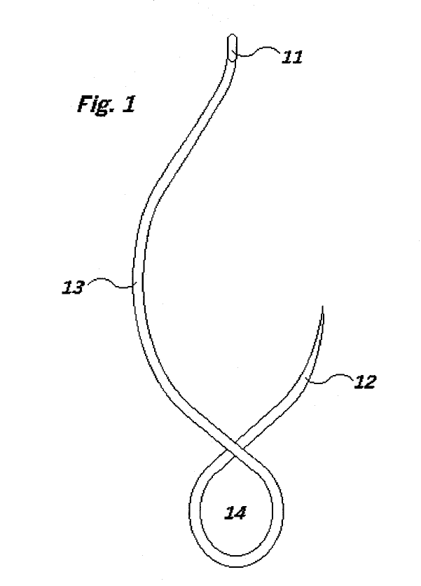

Referring first to FIG. 1 there is shown a typical embodiment of the basic design of the fishhook of the present invention having a eye 11 or other means of attachment to a line or leader and a barbless point 12 which may be of any desired design and are not part of the present invention. As will be made obvious by the ensuing description, the fishhook of the present invention is easily constructed using both materials and techniques similar to the construction of other fishhooks of previous invention. No specialized materials, methods, or skill is required. Starting at the eye 11 and terminating at the point 12 is a curved shank 13 formed possibly from a wire or some similar material. In the present invention, the wire or similar material of the shank 13 is additionally lengthened and bent in a generally circular fashion such that when viewed from this perspective it overlaps itself to form a loop 14 of predetermined diameter as shown in the drawing. The length of the shank 13 is increased by the circumference of the loop 14.

When the fish bites on the fishhook of FIG. 1 the point 12 is caught on and becomes embedded in the tissue of the fish in the manner of conventional fishhooks of previous invention. Upon a jerk on the line by a angler or the struggle of the fish itself the point of the fishhook of present invention penetrates deeper into the tissue of a fish while the entire hook body simultaneously rotates one hundred and eighty degrees such that when the fishhook is fully engaged a portion of the tissue of the fish becomes entrapped in the loop 14 portion of the hook body. This novel loop 14 of the present invention firmly both holds and binds the entrapped tissue of the fish until fishhook is intentionally removed by the angler.

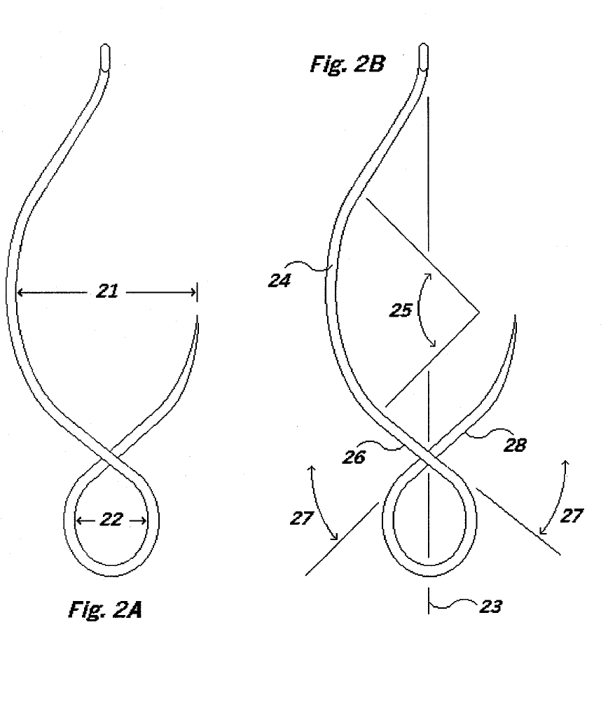

FIG. 2A demonstrates the proportional relationship of the typical embodiment of the fishhook of FIG. 1, wherein the diameter 22 of the loop 14 section of the fishhook body is generally, but not limited to, one half of the distance 21 between the shank 13 and the point 12 of the fishhook. FIG. 2B shows that the loop 14 section of the fishhook body of FIG. 1 is located on the central longitudinal axis 23 of the fishhook body generally opposite of the eye 11 or other means of attachment to a line or leader. Also shown is that the upper portion 24 of the shank 13 is generally curved to form an angle 25 of approximately ninety degrees wherein the portion 26 of the shank 13 leading into the loop 14 is generally no more than forty five degrees offset from the central longitudinal axis 23 of the hook body. Additionally the loop 14 section of the hook body is generally curved to form an angle 27 of approximately two hundred and seventy degrees such that the portion 28 of the shank 13 leading into the point 12 is also approximately forty five degrees offset from the central longitudinal axis 23 of the hook body and generally parallel to the upper portion 24 of the shank 13 of the fish hook.

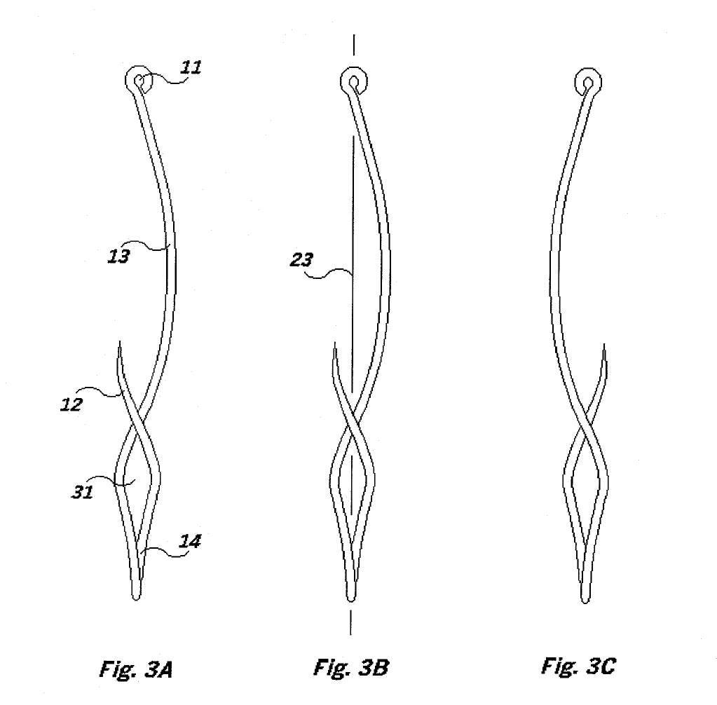

FIGS. 3A, 3B, and 3C show the fishhook of FIG. 1 from various different aspects. FIG. 3A shows the fishhook of FIG. 1 rotated ninety degrees to the right around the longitudinal axis 23 of the hook body. FIG. 3B makes obvious the longitudinal axis 23 of the fishhook of FIG. 3A. FIG. 3C shows the opposite perspective of FIG. 3A wherein the fishhook of FIG. 1 is rotated two hundred and seventy degrees to the right around the longitudinal axis 23 of the hook body.

FIGS. 3A, 3B, and 3C additionally illustrate the preferred embodiment of the fishhook of the present invention wherein the shank 13 is formed such that the entire hook body has a slight twist around its central longitudinal axis 23 that facilitates the intended rotation of the entire hook body by one hundred and eighty degrees when the hook is set in the tissue of a fish. In the preferred embodiment the twist is formed in a manner such that the hook body rotates to the right when penetrating the tissue of the fish. When the hook is disengaged from the fish it must be pushed backward and rotated in the opposite direction by the angler. It is preferred that the direction of rotation required to disengage the hook body be to the left. This facilitates ease of removal by the angler as the fishhook of the present invention will be removed from a fish in a manner similar to removing a standard machine nut, bottle cap, pipe fitting, or the like.

When viewed from these perspectives it is also obvious that in the preferred embodiment the slight twist formed in the hook body of the fishhook of the present invention creates a gap 31 of predetermined width at the top of the loop 14. The gap 31 allows the tissue of the fish to pass into the loop when the hook is engaged in the manner previously described. Additionally, in the preferred embodiment of the present invention, the wire or similar material of which the shank 13 is formed is flattened parallel to the longitudinal axis 23 of the hook thereby increasing the resistance of the hook body to deformation when the point of the hook is set in the tissue of a fish. This in turn allows use of a smaller diameter wire or other similar material for the shank 13, which both lightens the hook body and further increases ability of the hook point 12 to effect penetration.

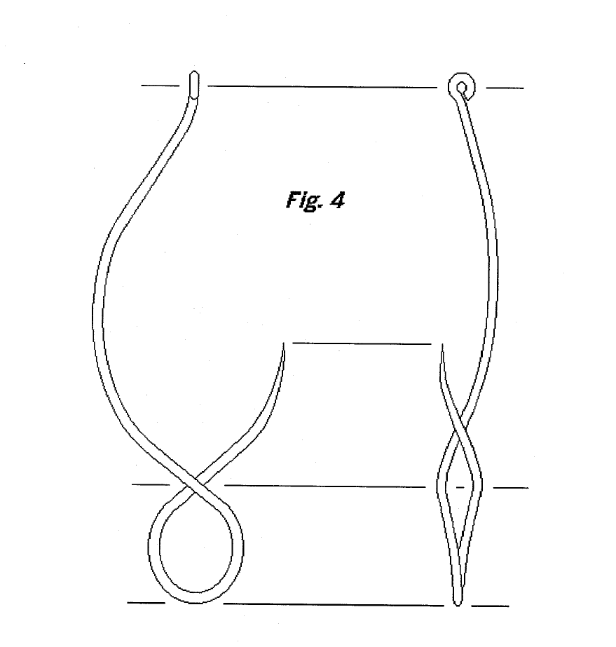

FIG. 4 illustrates the correlating parts of previous perspectives of the fishhook of FIG. 1 for reader clarification.

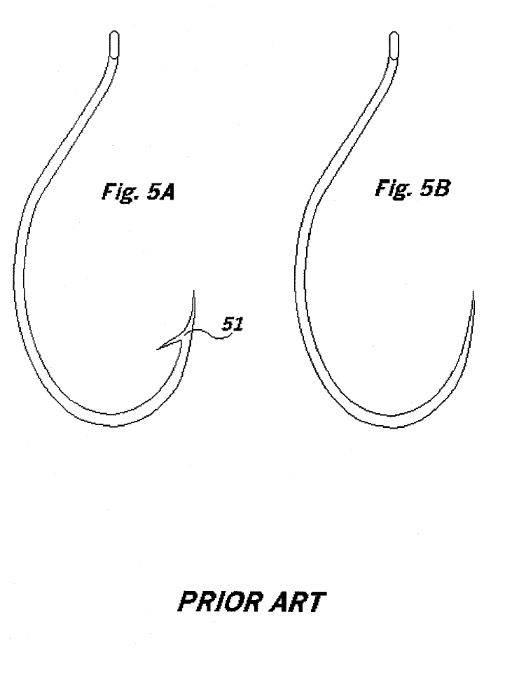

FIG. 5A and FIG. 5B show prior art. FIG. 5A illustrates a typical embodiment of a fishhook of previous invention including a barb 51 for the purpose of retaining the hook in the tissue of a fish. FIG. 5B shows a typical barbless version of the fishhook of FIG. 5B. For the purpose of illustration, the overall shape of the hook body of FIGS. 5A and 5B is similar to the portion of the hook body of FIG. 1 located above the loop 14 section of the fishhook of FIG. 1. The novel loop 14 that holds and binds the tissue of a fish is formed in the shank 13 of the of the of the fishhook of the present invention in addition to and irrespective of the overall predetermined size and shape of the fish hook body. The overall size and shape of the hook body is predetermined by both the size of the species of fish sought and method of fishing preferred by the angler.

### CONCLUSIONS RAMIFICATIONS AND SCOPE

Accordingly, the reader will see that irrespective of the species of fish sought or the method of fishing preferred nearly any fishhook of present use will be substantially improved by the addition of the loop designed to reliably hold and bind the fishhook of the present invention in the tissue of a fish. Furthermore the Loop Fishhook has the additional advantages in that

it provides a fishhook that easily penetrates the tissue of a fish and remains embedded in a fish until intentional removal by an angler;

it provides a fishhook that can be removed from a fish quickly and without difficulty and that can be removed from a fish with little or no injury to the fish;

it provides a fish hook of simple design and inexpensive manufacture;

it provides a fishhook adaptable in overall size and shape that is effective in all methods of angling for all species of fish; and

it provides a fishhook that combines the advantages of both barbed and barbless fishhooks of present use and a fishhook which is compatible with current standard sport fishing techniques and legal to use where barbed hooks are prohibited.

It will be obvious to those skilled in the are that various changes may be made without departing from the scope of this invention. While the description above contains many specifications, these should not be constructed as limiting the scope of the invention but as merely providing examples of some of the presently preferred embodiments of the invention. Thus the scope of the invention should be determined by the appended claims or their legal equivalents rather than by the examples given.

I claim:

1) A fishhook with improved fish retention characteristics,
said fishhook comprising
a hook body comprised of a shank having a method for attachment to a line or leader and terminating in a sharp point,
said shank having a curved section including a novel loop of a predetermined diameter formed in said shank,
whereby the tissue of a fish can be held and will bind in said loop when said fish is caught on said fishhook.

2) The fishhook of claim 1 wherein said hook body is constructed of a wire of a generally uniform cross section.

3) The fishhook of claim 2 wherein said wire is of a predetermined diameter appropriate for the size of the species of fish sought.

4) The fishhook of claim 1
wherein said hook body is of a predetermined
size appropriate for the species of fish sought, and
shape appropriate for the method of fishing.

5) The fishhook of claim 1
wherein said loop is integral with and forms a part of said shank, and
said loop is located on said hook body generally opposite of said method of attachment to line or leader, and
said loop having a diameter generally large enough to hold or bind said hooked tissue of a fish.

6) The fishhook of claim 1
wherein said point is integral with and forms a part of said shank and
wherein said point is barbless
thereby decreasing resistance to penetration of said point in the tissue of a fish, and
thereby decreasing damage to the tissue of a fish upon removal of said fishhook from said fish, and
thereby facilitating removal of said fishhook from the flesh of a angler upon accidental hooking of said flesh.

7) The fishhook of claim 1
wherein said fishhook has a central axis located between the furthest opposing ends of said hook body,
said shank curves around said axis of said hook body, and
said point curves around said axis of said hook body in an opposing direction from said shank,
thereby causing said hook body to rotate 180 degrees when said point is embedded in the tissue of a fish and said line or leader is pulled upon,
whereby said tissue of said fish is held in said loop.

8) A barbless fishhook comprising a hook body having a curved shank portion with opposing ends thereof and terminating in a sharp point, wherein is included a means for attachment to a line or leader, the improvement wherein said shank has a novel loop whereby the tissue of a fish can be held in said loop when a fish is caught on said fishhook.

9) The fishhook of claim 8 wherein said hook body is constructed of a wire of a generally uniform cross section.

10) The fishhook of claim 9 wherein said wire is of a predetermined diameter appropriate for the size of the species of fish sought.

11) The fishhook of claim 8
wherein said hook body is of a predetermined size and predetermined shape appropriate for the species of fish sought.

12) The fishhook of claim 8
wherein said hook body is of a predetermined size and predetermined shape appropriate for the method of fishing used.

13) The fishhook of claim 8
wherein said loop is integral with and forms a part of said shank, and
said loop is located on said hook body generally opposite of said method of attachment to line or leader, and
said loop having a diameter generally large enough to hold the hooked tissue of said caught fish.

14) The fishhook of claim 8
wherein said point is integral with and forms a part of said shank, and
wherein said point is barbless
thereby decreasing resistance to penetration of said point in the tissue of a fish, and
thereby decreasing damage to the tissue of a fish upon removal of said fishhook from said fish, and
thereby facilitating removal of said fishhook from the flesh of a angler upon accidental hooking of said flesh.

15) The fishhook of claim 8
wherein said fishhook has a central axis positioned between the outermost opposing ends of said hook body,
said shank curves around said axis of said hook body, and
said point curves around said axis of said hook body in an opposing direction from said shank,
thereby causing said hook body to rotate 180 degrees when said barbless point is embedded in the tissue of a fish and said line or leader is pulled upon,
whereby said tissue of said fish is held in said loop.
